(19) United States
(12) Patent Application Publication
(10) Pub. No.: US 2003/0234151 A1
(43) Pub. Date: Dec. 25, 2003

(54) Harmonic drive comprising a coupling and a driving core for a harmonic drive of this type

(76) Inventor: Frank Poehlau, Fuerth (DE)

Correspondence Address: Horst M Kasper, 13 Forest Drive, Warren, NJ, 07059, US

(21) Appl. No.: 10/258,256

(22) PCT Filed: Mar. 17, 2001
(86) PCT No.: PCT/EP01/03090

(30) Foreign Application Priority Data
Apr. 20, 2000 (DE) 100 19 577.6

(51) Int. Cl. F16D 11/00; F16D 13/60

(52) U.S. Cl. 192/110 R

(57) ABSTRACT

A shaft transmission can be equipped with an integrated gently switching neutral clutch by means of a drive core widening approximately conically, which is axially displaceable relative to the inner wheel between a tapered and round free region (12.2) and a non-circular drive region (12.1). For changing of gears a shifting claw engaging in a circular groove on the drive core (12.1) for its axial displacement in the inner wheel (10).

The present invention relates to a shaft transmission with coupling and a drive core therefor, in accordance with the preamble of the respective principal claim.

The function of a shat gear—known as harmonic drive, as flex band drive or as toroidal drive—being a strongly reducing, irreversible system with the driven shaft coaxial to the drive shaft is based on the fact that a rotating so-called shaft wave generator distorts an inner gear ring, the so-called flexspine designated as a flex band radially revolving and thereby presses its outer mantle surface locally outwards against the hollow-cylindrical inner mantle surface of slightly larger circumference of a stationary, dimensionally stable support ring, the so-called circular spine. Consequently, the inner gear itself or its tyre mounted rotatably thereon moves on rolling contact non-positively by way of frictional surfaces or positively by way of gearing in the support ring, i.e. local tooth engagement between flex and circular spine, such that the wheel or its tyre rotates more slowly than the motor-driven drive core of the shaft generator according to the magnitude of the difference in circumference. This rotational movement slowing sharply compared to the drive is preferably transferred by way of the outer gearing of the gear ring to the inner gearing of another hollow-cylindrical outer ring of the driven ring concentric to the support ring but not stationary. The shaft generator is driven by means of a coaxially formed high-speed (and therefore expensive) extra-low voltage direct-current motor whose rotation is reduced to a very much slower rotational movement of correspondingly greater torque. This type of motor-gear combination has application in particular in electromechanical control devices in vehicles. When application requires the power transmission to be interrupted by this gear a no-load clutch is positioned before it in the drive shaft or after it in the driven shaft, which constitutes a fundamental disadvantage as a result of additional functional components susceptible to wear and greater spatial requirements.

In the embodiments of such shaft transmissions known from the generic German utility model 2 96 14 738 and described in greater detail in the article ‘Ingeniously simple’ by H. Hirn (KEM Antriebstechnik Vol 11/1996) a non-circular (approximately triangular or preferably oval in the axial cross-section) drive core is rotated concentrically as shaft generator in the hub of the radially deferrable inner wheel. The effect of the dimensionally stable spokes between the hub radially deformable by the drive core and the likewise deformable, externally toothed tyre acting as radially oriented tappets is that the outer gearing corresponding to its revolving radial deformation engages with the inner gearing of the support ring only by means of a limited segment moving therein on rolling contact. The radially displaceable outer gearing can be arranged directly on the heads of T-shaped tappets or on a tyre (flex band) revolving over these heads, whereby in the latter case the inner wheel can also be idle and may even be designed as a guide cage for tappets displaceable radially therein by the shaft generator.

The technical task of the present invention is to develop the previously known shaft transmission, in adhering to the apparatus and application-oriented advantages, to the effect that it is no longer necessary to employ an external coupling for interrupting the power flow from the drive motor to the driven shaft.

The solution characterized in the principal claims has the advantage of having integrated an extraordinarily simple and easily controlled coupling function directly into the shaft transmission, without any additional expenditure on special apparatus, that is, installed in its shaft generator, without having to enlarge the radial dimensions of the shaft transmission for this purpose.

The initial thinking for this solution was that only the non-circular drive core of the shaft transmission leads to the abovedescribed seesawing of the inner wheel in the support ring. A drive core axially displaceable relative to the inner wheel is provided according to the present invention, which presents a non-circular (in axial cross-section particularly oval) so-called drive region over a part of its axial length, and over a part of its length offset axially thereto presents a free region having a round axial cross-section of a diameter which is no greater than the smaller of the two diameters of its non-circular region. This round region of the drive core can thus spin in the hub of the inner wheel, without resulting in the localized revolving radial loads for their seesawing in the support ring. Accordingly, the corresponding axial displacement of the drive core changes gear in the inner wheel between rotation movement and idling of the outer gearing of the inner wheel and thus of the driven ring also.

If a sliding transition between both these functional areas of varying cross-section geometry is arranged, thus a gradual oval broadening of the drive core from the round region out, a particularly gentle switching procedure is set in motion because th revolving drive core engages only gradually with its increasingly non-circular cross-section with the inner wheel to be deformed radially. Relative to the axial thickness of the inner wheel resting thereon the free region has adequate axial length for a neutral position in the inner wheel.

For the drive core to be moved for coupling and decoupling of power transmission by way of the shaft transmission it suffices to arrange a shifting daw preferably on the drive side, therefore in the formed drive motor, which engages in a forked manner in a circular groove in the drive core near the bearing area. Only this one additional component is required to realize and handle such a neutral clutch with conical non-circular drive core.

With respect to other advantages, features and further developments, reference is made to the following description of an embodiment for a drive core in a switching shaft transmission according to the present invention, apart from the other claims. In the diagram:

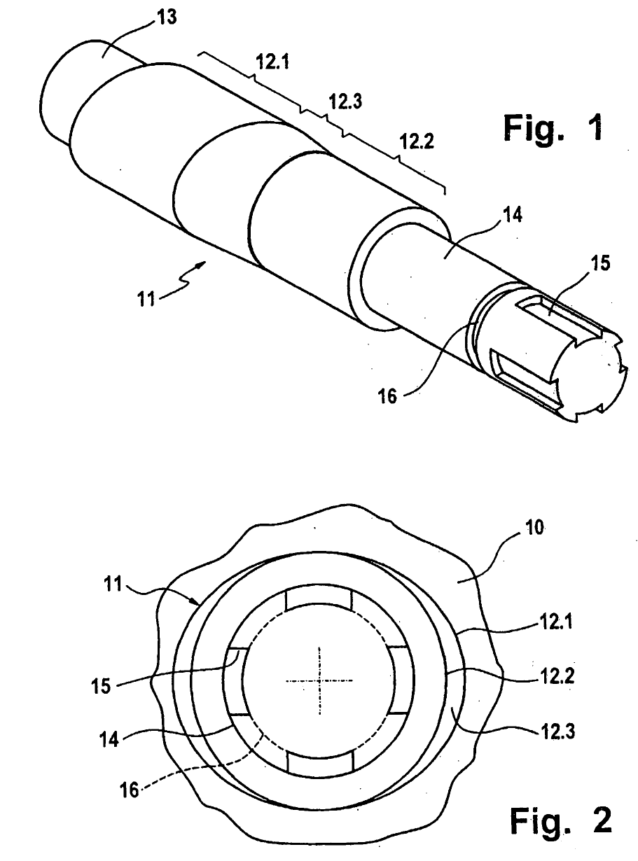

FIG. 1 shows the drive core in an oblique view, and

FIG. 2 shows a frontal view of the drive core from FIG. 1 in dismantled state in the neutral position with its round free region penetrating the hub of the inner wheel of a shaft transmission.

As illustrated in greater detail in the introductory publications in a shaft transmission the radially deformable inner wheel 10 (FIG. 2) is penetrated coaxially by the revolving non-circular drive core 11 of the so-called shaft generator in the dimensionally stable hollow-cylindrical support ring, not illustrated here. Arranged offset axially on said drive core 11 is a free region 12.2, according to the present invention compared to a non-circular drive region 12.1 oval in cross-section in particular. As is evident from the frontal view of FIG. 2 the round diameter of free region 12.2 corresponds to the smaller of the two elliptical diameters of drive region 12.1. Accordingly the drive core can spin in inner wheel 10 without radial load, whenever drive core 11 penetrates inner wheel 10 with this region 12.2, as in FIG. 2. If inner wheel 10 is displaced axially relative to drive core 11 as far as drive region 12.1, inner wheel 10 experiences from revolving drive core 11 its revolving radial deformation for retarded seesawing in the support ring.

If the transition from free region 12.2 to drive region 12.1 is not stepped, rather, as indicated in FIG. 1 of the diagram, runs constantly over a conical widening or tapering transition region 12.3, a sliding engagement or disengagement of drive region 12.1 is achieved with axial displacement between inner wheel 10 and drive core 11 in the hub of inner wheel 10, thus resulting in a particularly gentle switch procedure.

Apart from said (not directly) adjacent functional regions 12 drive core 11 is tapered to a journal 12, which engages rotatably and longitudinally displaceably in the hub of the driven ring (not illustrated here, and to another journal 14 which penetrates an end shield (not illustrated here) of the shaft transmission. Said drive-side journal 14 terminates at the front end in a connection profile 15 for non-positive torsional engagement in a sleeve-like front opening in the coupling bushing on the shaft of the drive motor (not illustrated here) formed on the transmission. Connection profile 15 parallel to the axis extends over at least the length of transition region 12.3, therefore the length from the beginning of free region 12.2 as far as the beginning of drive region 12.1, such that the drive-side front end of drive core 11 can be displaced axially and collision-free in its coupling to the drive motor integral with the device.

For this axial displacement of drive core 11, therefore for coupling ad decoupling in inner wheel 10, a switching claw (not illustrated here) swivel-mounted on the device can engage in a forked manner radially in a circular groove 16 which is cut in between drive-side journal 14 and connection profile 15 in drive core 11, as illustrated.

In accordance with the present invention, in practical terms without additional expenditure on apparatus and without substantial enlargement of the structural dimensions a shaft transmission can be equipped with an integrated gently switching neutral clutch by means of a drive core 11 widening approximately conically, which is axially displaceable relative to inner wheel 10 between a tapered and particularly round free region 12.2 and a non-circular drive region 12.1.

1. A shaft transmission equipped with a neutral clutch having a drive core (11) revolving about its axis, whose non-circular cross-section results in coaxial seesawing of the tyre of a radially deformable inner wheel (10) surrounding it and particularly in the shape of a spoke wheel in a dimensionally sable support ring of approximately greater diameter, characterized in that the inner wheel (10) and the drive core (11) are axially displaceable relative to one another between the non-circular drive region (12.1) and a particularly round free region (12.2) offset axially thereto and tapered over at least the axial thickness of the inner wheel (10) in the axial cross-section.

2. Drive core (11) for a shaft transmission as claimed in claim 1, characterized in that a tapered, particularly round free region (12.2) is arranged thereon next to a non-circular, particularly elliptical axial cross-section as drive region (12.1).

3. Drive core as claimed in claim 2, characterized in that the free region (12.2) extends over at least the axial thickness of the inner wheel (10) borne thereon.

4. Drive core as claimed in claim 2 or 3, characterized in that a transition region (12.3) extends between the drive and free regions (12.2, 12.2), in which the cross-section varies constantly between the tapered cross-section of the free region (12.2) and the non-circular cross-section of the drive region (12.1).

5. Drive core as claimed in any one of the foregoing claims from claim 2 onwards, characterized in that journals (13, 14) connect on both sides of the functional regions (12).

6. Drive core as claimed in any one of the foregoing claims from claim 2 onwards, characterized in that a circular groove (16) for engaging a switching claw for axial displacement of the drive core (11) connects to one of the journals (13, 14).

7. Drive cor as claimed in any one of the foregoing claims from claim 2 onwards, characterized in that a connection profit (15) for the shaft of a drive motor is connected to a drive-side journal (14).

8. Drive core as claimed in any one of the foregoing claims, characterized in that the axial length of the connection profile (15) corresponds to at least the length of the axial displacement of the inner wheel (10) between the drive region (12.1) and free region (12.2).

4. Drive core as claimed in claim 2, characterized in that a transition region (12.3) extends between the drive and free regions (12.2, 12.2), in which the cross-section varies constantly between the tapered cross-section of the free region (12.2) and the non-circular cross-section of the drive region (12.1).

5. Drive core as claimed in claim 2, characterized in that journals (13, 14) connect on both sides of the functional regions (12).

6. Drive core as claimed in claim 2, characterized in that a circular groove (16) for engaging a switching claw for axial displacement of the drive core (11) connects to one of the journals (13, 14).

7. Drive core as claimed in claim 2, characterized in that a connection profile (15) for the shaft of a drive motor is connected to a drive-side journal (14).

8. Drive core as claimed in claim 2, characterized in that the axial length of the connection profile (15) corresponds to at least the length of the axial displacement of the inner wheel (10) between the drive region (12.1) and free region (12.2).
